(19) United States
(12) Patent Application Publication
(10) Pub. No.: US 2017/0017985 A1
(43) Pub. Date: Jan. 19, 2017

(54) INTERACTIVE COMMERCIAL BILLIARD LIGHTING FIXTURE WITH INTEGRATED WI-FI CONNECTED TO CONTENT MANAGED DIGITAL SIGNAGE

(71) Applicant: Troy M. Stacy, Upper Arlington, OH (US)

(72) Inventor: Troy M. Stacy, Upper Arlington, OH (US)

(21) Appl. No.: 15/213,208

(22) Filed: Jul. 18, 2016

Related U.S. Application Data
(60) Provisional application No. 62/231,824, filed on Jul. 17, 2015.

(51) Int. Cl. G06Q 30/02; H04R 1/02; G06K 19/06

(52) U.S. Cl. CPC G06Q 30/0241; G06K 19/06037; G06K 19/06028; H04R 1/02

(57) ABSTRACT

The present invention is a device which comprises an illuminating lamp that provides lighting for the top of a pool or other game table. The invention also comprises a processor that provides content to be displayed or otherwise broadcast by embodiments of the invention using graphics displays that are configured to provide nearby users with the promotional or entertainment content. The invention also comprises a wireless communications system that may be used by an administrator to manage the promotional or entertainment content displayed by the invention.

### CROSS-REFERENCE TO RELATED APPLICATION

This application claims priority to provisional application 62/231,824 filed on Jul. 17, 2015 and is incorporated by reference in its entirety as if fully recited herein.

### TECHNICAL FIELD

Exemplary embodiments of the present invention relate generally to On-Premise branded digital content marketing & entertainment.

### BACKGROUND AND SUMMARY OF THE INVENTION

Historically beer, spirit and lifestyle brands who market themselves within bar and tavern locations have manufactured or hired out for manufacture and creation of various signage and advertising materials. Examples may include posters, enameled signage, and neon displays. In addition, such advertising materials have included functional items such as menu boards, table covers and lighting fixtures, including billiard lighting fixtures featuring the painted, decaled or wrapped likeness of a brand and may include the brand's marks, logo and slogan. Because of the static nature of these materials, a manufacturer or other entity wishing to promote a brand using such methods was required to select the design of the advertising material, create the content and then have the item produced or modified to present the selected material. Additionally, the selection of new or updated content could result in a delay before the newly implemented advertising material can be implemented.

In addition to the time expenditure required to update content, these types of materials are typically static in nature, that is, they do not interact with the viewer. With the advent of smartphones and widespread wireless data communications (Wi-Fi), members of the public and therefore potential advertising targets, are more attracted to and generally expect a more interactive experience when it comes to advertising material. As a result, what is needed is an interactive, easily updated or modified device for delivering interactive advertising content to a target audience. Additionally, a device for presenting such content may be more effective when positioned in an area that receives a large number of views by a target audience. For purposes of the present invention, an embodiment of the present invention may be a light fixture for illuminating a pool table or other game table. In such an embodiment, the fixture may be positioned above the table such that the persons playing are able to directly view the presented advertising content. An embodiment of the invention may comprise the aforementioned light fixture, one or more graphics devices such as LCD or similar display devices, sound producing devices such as speakers, and a variety of communications devices that may facilitate a greater level of interaction with the intended audience of the material. For example, an embodiment of the present invention may allow beer, spirits and lifestyle brands to remotely present interactive and/or entertainment content on an integrated platform comprising a Wi-Fi connected, content managed digital signage and integrated audio system.

Further features and advantages of the devices and systems disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is an illustration of an embodiment of the invention;

FIG. 2 is a block diagram of an embodiment of the invention;

FIG. 3 is a block diagram of the data flow to and from the processor in an embodiment of the invention; and

FIG. 4 is a flow chart of major functions performed by the processor in embodiments of the invention.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

### Illumination of Game Table Surface

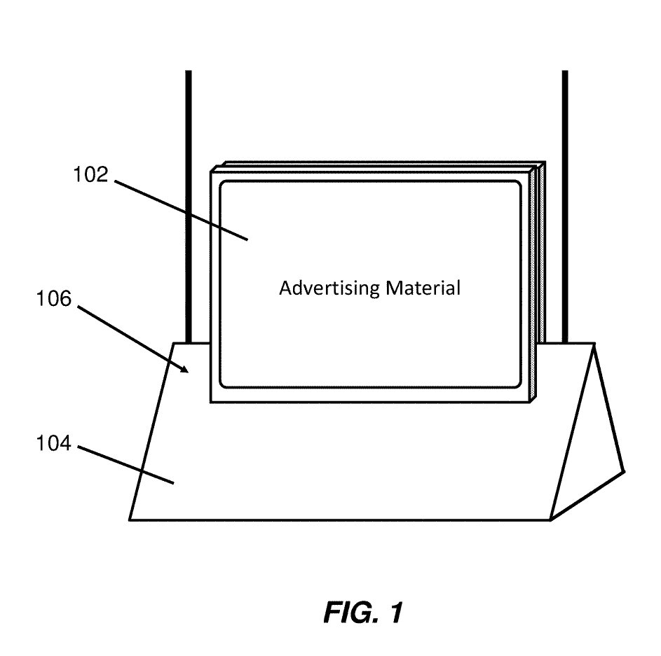

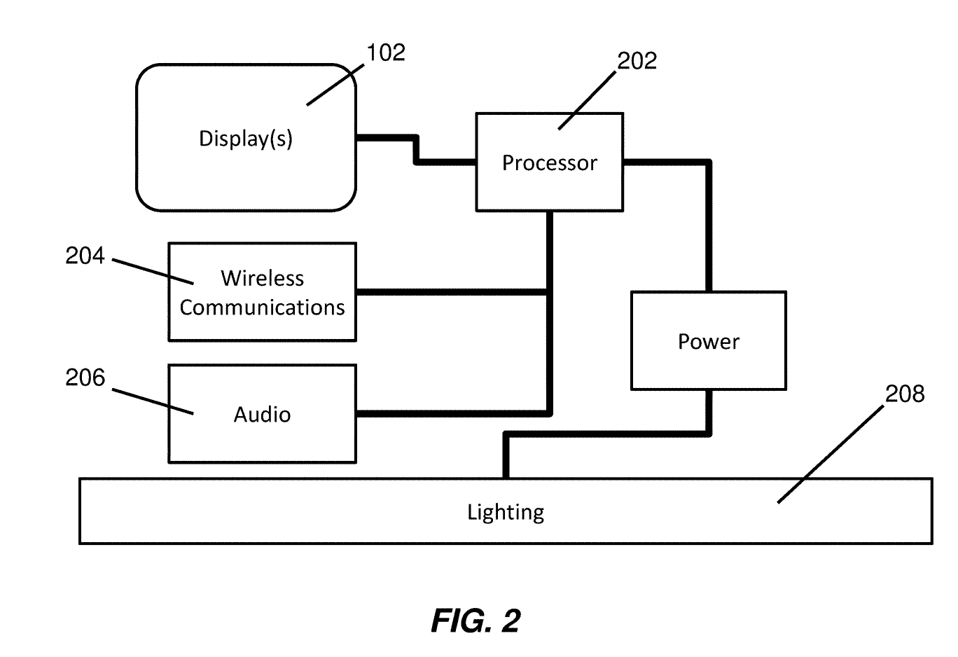

Billiards and other table based skill games are frequently located in establishments such as bars, pubs, restaurants, pool halls, and other gathering places. In addition to promoting the bar, etc. where the game is located, such establishments often wish to promote products and services that may be of interest to those frequenting the bar, pub, etc. Because of the nature of the location, the table-based games are not generally located near walls, but instead are located in more open areas. Because of the lack of wall space in such areas, known methods of promotion are often limited to table top displays which generally are simple cardboard flyers. Game tables are frequently equipped with lights suspended from above the table that direct light onto the playing surface. In embodiments of the invention, one or more electronic display and wireless communication devices may be positioned within a lamp, which is configured to be suspended above a game table. An example embodiment is illustrated in FIG. 1. In the embodiment shown, a pair of back-to-back graphics displays 102 are mounted centrally along the top of the illumination portion 104 of the invention. The embodiment illustrated is primarily to assist the reader in their understanding of the invention. The, size, location and number of displays is not intended to be limited by the illustration. For example, and without limitation, an embodiment could be comprised of four display devices, one located at each face of a rectangular light fixture. In certain embodiments, the light fixture may be rounded, rectangular, oval or configurations with any number of sides. In addition to the graphics displays 102, the illumination portion 104 may also comprise print advertising applied to the exterior surfaces of a light enclosure 106. As is illustrated in FIG. 2, the light enclosure 106 may also contain electronic components such as a processor 202 which supplies images to the graphics displays 102, wireless communication circuitry 204, and audio circuitry 206 for the delivery of music or audio content in conjunction with what is displayed on the graphics displays. In addition to these electronic components, the light enclosure 106 may also comprise lighting 208, which may be, without limitation, fluorescent, LED, halogen, or traditional incandescent lamps.

### Remote, Wi-Fi Connected Content Management

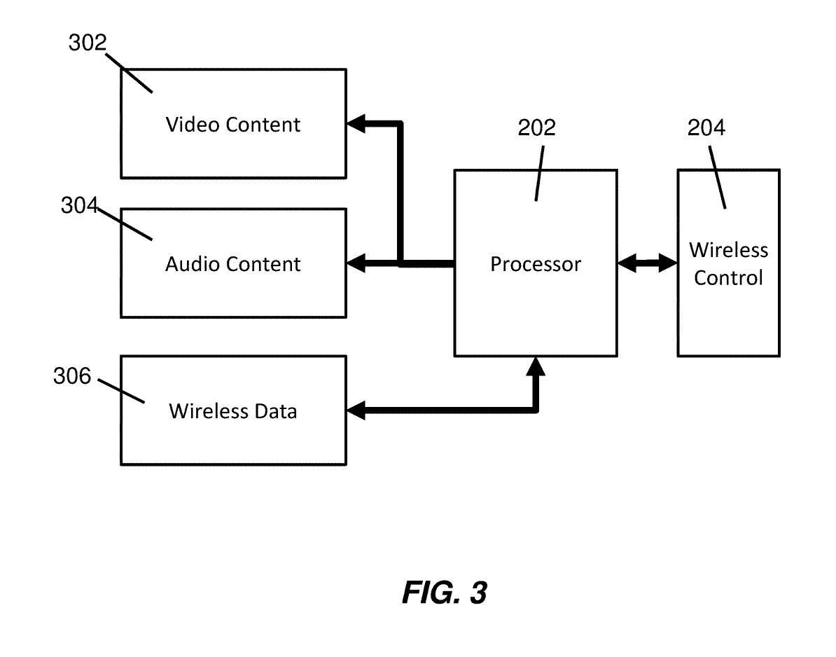

As was noted above, an embodiment of the invention may comprise wireless communications circuitry. This circuitry may comprise Wi-Fi circuitry that is configured to allow an administrator to wirelessly connect to an embodiment of the invention in order to manage the content displayed or otherwise broadcast by the invention. As is illustrated in FIG. 3, a wireless connection 204 may be in electronic communications with the processor 202 or to configure the processor to perform certain functions. The administrator may use this connection to provide content to the processor 202. As is illustrated, this content may comprise video content 302, audio content 304, and wireless data 306 that is provided to users by embodiments of the invention. Using a wireless connection may permit the invention to be located remotely from the administrator and allow the administrator to maintain or update content without interfering with those who may be using the game table with which the invention is associated. The material may be provided via a Wi-Fi “stream” such that the material is not necessarily stored in the processor 202 of the invention but instead is provided by an external computerized content manager. Alternatively, embodiments of the invention may store content in the processor 202 for autonomous display. In other words, display of the desired material may take place without an active connection to an external computerized content manager.

Embodiments of the invention may be configured for display of video content via a Wi-Fi connection to manage the content of digital signage. For example, the content of the invention may comprise digital versions of traditional advertising signage. For example, an advertisement for a beverage that is offered by the establishment where the invention is located. This content may be a series of still images that simulate traditional printed media or it may be video content such as is used in television commercials. Additionally, video or still content may be optimized to take advantage of the interactive functionality of embodiments of the invention as described herein.

In order to attract or retain the attention of a viewer or user who is in the vicinity of an embodiment of the invention, embodiments of the invention may be configured to display curated social media. For example, news and entertainment content that is obtained from various social media sources. Such content may be interspersed with the advertising material previously described. This content of the invention may be managed through the use of a wireless connection to a content manager or administer. In such manner, the curated social media content may be regularly updated to improve the experience to the viewer, thus retaining that viewer's interest longer then would be possible with a static display or a continuous loop of material that is infrequently updated.

In addition to imagery, the content displayed by embodiments of the invention may include codes such as quick response (QR) codes that can be scanned by viewers using a smart phone or similar electronic device that is equipped with QR reader software. In certain embodiments of the invention, such codes can be used to direct the electronic device to a particular web page. The web page may be configured so that the user can chose to receive more information about a promoted item. One ordinarily skilled in the art will understand that other types of embedded codes may be used. Another example may be, without limitation, bar codes.

### Onboard Near Field Communication

In addition to Wi-Fi connections, embodiments of the invention may also be equipped with near field communication devices. In such an embodiment, a user may be prompted to hold their smart phone or other electronic device in close proximity to a portion of the light enclosure 106 in order to send or receive digital content. Received content may enable the user to connect directly to branded content through the electronic device. In addition, the user may transmit information to embodiments of the invention. Such transmitted information may be requests for more information with regard to the content displayed by the invention. Alternatively, the user may supply payment information to purchase an item promoted by an embodiment of the invention or to purchase music, games, or other entertainment content available from embodiments of the invention.

Wireless communications capability may also include Blue Tooth iBeacon technology that is configured to serve relevant offers to users on their mobile devices when those mobile devices come into proximity with embodiments of the invention. For example, an embodiment of the invention may communicate with an application on a smart phone to trigger a notification to a user that new content is ready to be viewed or a game or other offer is available that may be of interest to a user.

### User Opt-In

In embodiments of the invention, a user may be prompted to opt-in to various digital content that may be made available by an embodiment of the invention using the aforementioned wireless communications methods. This opt-in may be facilitated by one of the mobile connectivity capabilities of the invention such as near-field communications. In certain embodiments of the invention, the graphics display 102 may be configured with touch screen input device. In such embodiments, the user may interact with the graphics displays to opt-in or otherwise interact with the invention.

The invention may be configured such that it communicates and interacts with either proprietary or partnered mobile device connectivity. For example, a near field communications capability of the invention may be configured such that it triggers a proprietary software application running on a user's smart phone. Examples of applications include, but are not limited to, applications that enable a user to interact with an embodiment of the invention. A particular example may be a software application that converts the user's mobile electronic device into a game controller that may be used to play a game offered by an embodiment of the invention. Examples of such games may be interactive gaming such as a first-person exploration game or a trivia game in which various users may compete with each other to correctly guess the greatest number of questions.

Other input and output devices may be configured by embodiments of the invention to provide further functionality for the invention. For example, Wi-Fi connected digital cameras may be located within or on the light enclosure 106. These cameras may be used to interact with the user or monitor the environment or game table above which the invention is located. This configuration may allow an administrator to remotely monitor the activities of a user or may be used to enhance the user experience by providing images to integrate into the various content provided by embodiments of the invention.

In certain embodiments of the invention, digital or holographic projectors may be used in conjunction with or instead of the graphics displays 102. An example of such an embodiment may be a projector configured to display an image on the surface of the game table above which the invention is located. Such an image may be, without limitation, advertising, games, or other information useful to a user such as rules, or suggested actions that the user may take in order to improve their score in a game being played on the game table.

In addition to video displays, embodiments of the invention may also be configured to include on board blue tooth connected audio systems. Such systems may be used to provide audio content to images or videos being displayed on the graphics displays of the invention.

With the increasing popularity of wireless charging of mobile electronic devices, wireless mobile charging capabilities may be integrated into embodiments of the invention. These wireless chargers may be provided free to users to encourage those users to remain in close proximity to the embodiment so that the user is more likely to view the ad or other promotional content provided by embodiments of the invention. Alternatively, the invention may require some form of payment from the user in order for that user to utilize the invention's wireless charging capability.

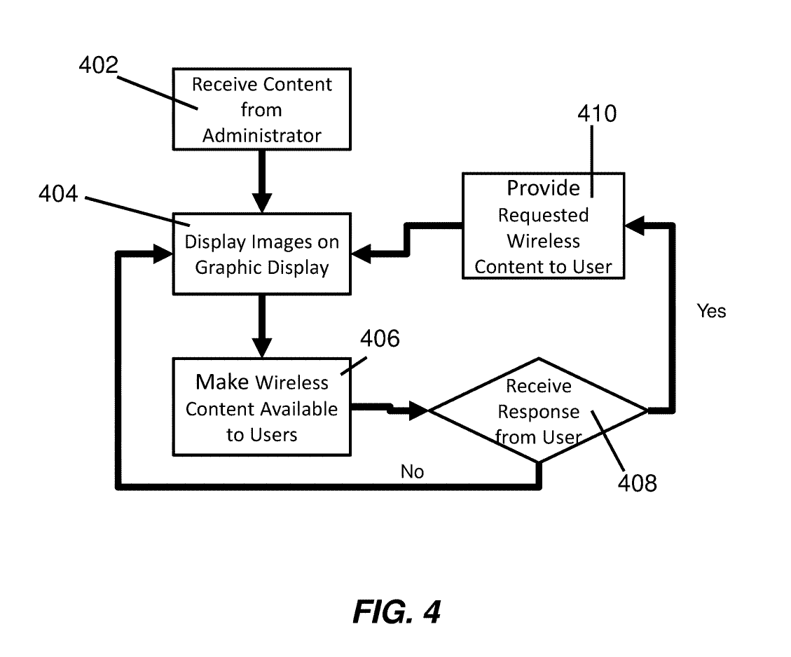

Referring to FIG. 4, in embodiments of the invention, the processor may be configured to receive content from an administrator 402 as previously discussed. The invention may display this content on a graphics display 404 or otherwise provide the content to users (for example, audio content may be produced using a speaker system). In addition to displaying content, wireless content may be made available to the users electronic devices 406. When a user responds to this wireless content, an embodiment of the invention may provide the requested information or product offering 410. As we described herein, such offerings may include interactive functions such as games. Embodiments of the invention may then continue the display of content as shown by the return to displaying images in step 404.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A system for providing promotional content to a viewer, the system comprising:
an illuminating lamp located in a lighting fixture;
a display device configured such that it is mounted on the lighting fixture in such a manner as to allow the viewer to see the display device when that user is engaged in a game activity on a table illuminated by the illuminating lamp;
a computer processor in communications with the display device;
a wireless communications device in communication with the computer processor; and
software instructions that configure the computer processor to perform the steps of:
receiving, using the wireless communications device, displaying content; and
displaying the display content on the display device.

2. The system of claim 1, further comprising a near field communications device in electronic communication with the computer processor and software instructions that configure the processor to send and receive data from a mobile electronic device in communication with the near field communications device.

3. The system of claim 1, further comprising a Blue Tooth iBeacon device in electronic communication with the computer processor.

4. The system of claim 1, further comprising a Blue Tooth enabled speaker system.

5. The system of claim 1, wherein the received display content comprises embedded digital codes.

6. The system of claim 5, where the embedded digital codes are quick response codes.

7. The system of claim 5, where the embedded digital codes are bar codes.

8. The system of claim 1, wherein the software instructions also comprise steps which configure the processor such that the received display content is stored for later display.

9. The system of claim 1, further comprising a digital camera in communication with the processor and software instructions that configure the computer processor to receive digital images from the camera and integrate those images into the received digital content.

10. The system of claim 1, further comprising a digital projector in electronic communication with the computer processor.

11. The system of claim 10, wherein the digital projector is configured to project an image onto a game table surface located below the system.

12. A method of providing digital content to a user comprising the steps of:
configuring a digital lighting fixture comprised of a computer, wireless communications hardware, a processor, a graphics display, and a light source configured to illuminate a game table performing the steps of:
receiving digital content from the wireless communications hardware;
storing the content in the processor; and
displaying the content on the graphics display.

13. The method of claim 12, further comprising the step of displaying a machine readable digital code on the graphics display.

14. The method of claim 13, wherein the displayed machine readable digital code is a quick response code.

15. The method of claim 12, further comprising the step of configuring a digital beacon to send a digital signal to a portable electronics device.

16. The method of claim 12, further comprising the step of transmitting a digital audio signal to a wireless speaker system where such digital audio corresponds to the digital content displayed on the graphics display.

17. A system for providing promotional content to a viewer, the system comprising:
an illuminating lamp located in a lighting fixture where the fixture is configured such that the lamp produces a downward facing illumination;
a plurality of display devices configured such that it is mounted on the lighting fixture in such a manner as to allow the viewer to see the display device when that user is engaged in a game activity on a table illuminated by the illuminating lamp;
a computer processor in communications with the display device;
a plurality of wireless communications devices in communication with the computer processor;
a speaker system in electronic communications with the processor; and
software instructions that configure the computer processor to perform the steps of:
receiving, using the wireless communications device, displaying content;
storing the received display content in the processor;
displaying the display content on the display device;
transmitting digital information to a mobile electronics device using at least one of the plurality of wireless communications devices; and
transmitting an audio content to the speaker system.
